(19) United States
(12) Patent Application Publication
(10) Pub. No.: US 2001/0013746 A1
(43) Pub. Date: Aug. 16, 2001

(54) Spark plug

(76) Inventors: Keiji Kanao, Chita-gun (JP); Seiki Nakagawa, Takahama-city (JP)

Correspondence Address: Pillsbury Madison & Sutro LLP, Intellectual Property Group, 1100 New York Avenue, N.W., East Tower, Ninth Floor, Washington, DC, 20005-3918, US

(21) Appl. No.: 09/761,835

(22) Filed: Jan. 18, 2001

(30) Foreign Application Priority Data
Jan. 18, 2000 (JP) 2000-8738
Dec. 19, 2000 (JP) 2000-385646

(51) Int. Cl. H01T 13/22

(52) U.S. Cl. 313/144

(57) ABSTRACT

A spark plug wherein a tip comprised of an iridium alloy essentially consisting of iridium is resistance welded through a relieving layer to a front end of a center electrode comprised of an iron-based alloy and a facing portion of a ground electrode and wherein the material of the relieving layer has a coefficient of linear expansion between the iridium alloy and the iron-based alloy and has a Young's modulus of elasticity smaller than that of the two alloys.

### CROSS-REFERENCE TO RELATED APPLICATIONS

This application is based upon and claims priority from Japanese Patent Applications No. 2000-8738, filed Jan. 18, 2000 and No. 2000-385646 filed Dec. 19, 2000.

### BACKGROUND OF THE INVENTION

1. Field of the Invention

The present invention relates to a spark plug provided inside a combustion chamber of an internal combustion engine and, more particularly, relates to an improvement of the bonding of an Ir alloy tip essentially consisting of iridium in a spark plug provided with such a tip at its ground electrode or center electrode.

2. Description of the Related Art

In recent years, to extend the plug service life and improve performance, a spark plug has been proposed, as disclosed in, for example, Japanese Unexamined Patent Publication (Kokai) No. 11-329668, comprising at the discharge gap an iridium tip comprised of an iridium alloy resistance welded as a spark discharge electrode member to a center electrode and/or ground electrode comprised of a nickel-based alloy essentially consisting of nickel.

Japanese Unexamined Patent Publication (Kokai) No. 11-329668 discloses to interpose, between the center electrode and/or ground electrode comprised of the nickel-based alloy and the iridium tip, a relieving layer comprised of a material having a coefficient of linear expansion in the range between the iridium tip and the nickel-based alloy and having a Young's modulus of elasticity smaller than the tip comprised of the iridium alloy and nickel-based alloy.

Summarizing the problems to be solved by the invention, even Japanese Unexamined Patent Publication (Kokai) No. 11-329668 cannot ensure sufficient bonding between the tip bonding portion of the center electrode and/or ground electrode and the iridium tip.

### SUMMARY OF THE INVENTION

An object of the present invention is to provide a spark plug having a sufficient bonding force between a tip bonding portion of a center electrode and/or ground electrode and a tip comprised of an iridium alloy.

According to the present invention, there is provided a spark plug provided with a center electrode; an insulator shell holding the center electrode; a ground electrode fixed at the insulator shell and facing the center electrode across a discharge gap; a tip comprised of an iridium alloy essentially consisting of iridium bonded to the center electrode and/or the ground electrode at facing portions of the electrodes; and a stress relieving layer arranged between the tip and a tip bonding portion of the center electrode and/or ground electrode to which the tip is bonded; the tip bonding portion being comprised of an iron-based alloy; and the relieving layer being comprised of an alloy including platinum having a coefficient of linear expansion between that of the iridium alloy and the iron-based alloy and having a Young's modulus of elasticity smaller than the iridium alloy and the iron-based alloy.

Preferably, the tip bonding portion is comprised of an iron-based alloy containing at least 50 wt % of iron, still more preferably an iron-based alloy containing at least 50 wt % of iron and a balance of at least one of chromium and aluminum.

Preferably, the coefficient of linear expansion of the relieving layer at 900° C. is 9.2×10⁻⁶ to 11.7×10⁻⁶ (/°C.).

More preferably, the relieving layer contains at least 60 wt % of platinum.

Still more preferably, a Young's modulus of elasticity of the relieving layer at 900° C. is not more than 15×10⁴ MPa and even more preferably at least 5× 10⁴ MPa.

Still more preferably, a thickness of the relieving layer is at least 0.2 mm and even more preferably not more than 0.6 mm.

Still more preferably, the tip contains at least 50 wt % of iridium and even more preferably contains at least 50 wt % of iridium and contains at least one of rhodium, platinum, ruthenium, palladium, and tungsten added to the iridium.

Preferably, the relieving layer is comprised of a first relieving layer arranged at the tip side and a second relieving layer arranged at the tip bonding portion, the coefficient of linear expansion of the first relieving layer is between the coefficient of linear expansion of the tip and the coefficient of linear expansion of the second relieving layer, and the coefficient of linear expansion of the second relieving layer is between the coefficient of linear expansion of the first relieving layer and the coefficient of linear expansion of the tip bonding portion.

Preferably, the tip is larger in outer circumference than the relieving layer.

### BRIEF DESCRIPTION OF THE DRAWINGS

These and other objects and features of the present invention will be more apparent from the following description of the preferred embodiments given with reference to the accompanying drawings, wherein:

FIG. 1 is a partial enlarged view of a ground electrode of a related art;

FIG. 2A is a schematic view of the state of the bonding interface in the initial state, while FIG. 2B is an explanatory view of the state of the bonding interface in the initial state;

FIG. 3A is a schematic view of the state of the bonding interface in the state after a durability test, while FIG. 3B is an explanatory view of the state of the bonding interface in the state after a durability test;

FIG. 4 is a semi sectional view of the overall configuration of a spark plug according to an embodiment of the present invention;

FIG. 5 is an enlarged view of facing portions of a center electrode and ground electrode in FIG. 4;

FIG. 6 is a sectional view of a tip bonding portion in FIG. 5;

FIG. 7 is a view of the relationship between the number of cycles and rate of separation in the related art and the present invention;

FIG. 8 is an explanatory view of the rate of separation;

FIGS. 9A is a partial sectional view of another embodiment of the present invention, while FIG. 9B is a partial sectional view of another embodiment of the present invention;

FIG. 10 is a view of the relationship of the coefficient of linear expansion and the rate of separation of the relieving layer at the interface; and

FIG. 11 is a partial enlarged view of a spark plug finding the relationship of FIG. 10.

### DESCRIPTION OF THE PREFERRED EMBODIMENTS

The present inventors made an intensive study of the reasons why it is still not possible to obtain a sufficient bonding strength of the tip to the electrode with the configuration disclosed in Japanese Unexamined Patent Publication (Kokai) No. 11-329668.

Therefore, the inventors researched the state of separation of an iridium tip at a tip bonding portion of a ground electrode in the configuration of the spark plug disclosed in Japanese Unexamined Patent Publication (Kokai) No. 11-329668.

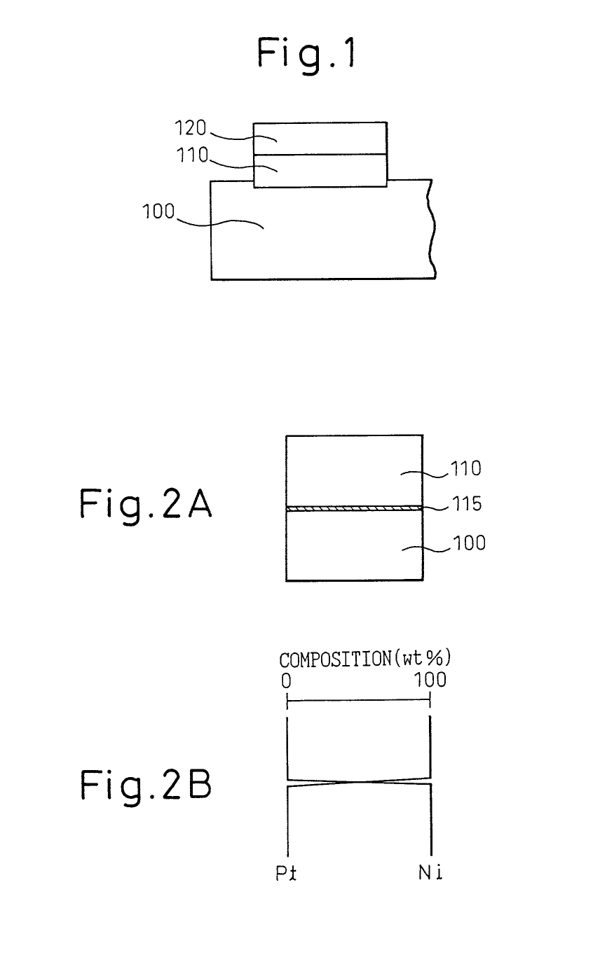

The spark plug used, as shown in FIG. 1, is comprised of a ground electrode 100 made of a nickel-based alloy comprised of Ni-15 wt % Cr-7 wt % Fe to which is resistance welded an iridium alloy tip 120 comprised of Ir-10 wt % Rh through a relieving layer 110 comprised of Pt-20 wt % Ir-2 wt % Ni.

Further, as the durability test, use was made of an electric furnace heat-and-cool cycle test. A cycle of exposure to an environment of 900° C. for 1 minute, then to an environment of 20° C. for 1 minute was performed for 400 times or conditions corresponding to a target service life (100,000 km) in an engine durability test.

As the degree of separation, separation was judged at the point of time when the ratio of the portion separating at the entire interface between the ground electrode 100 and the relieving layer 110 and the ratio of the portion separating at the entire interface between the relieving layer 110 and the iridium tip 120 become at least 25 percent.

A total of 100 samples were subjected to a durability test. As a result, separation of the joint occurred at 26 samples. The number of samples suffering from separation is shown in Table 1.

TABLE 1

| | Number of |
|---|---|
| Bonding location | separations |
| Between iridium tip and relieving | 0 |
| layer | |
| Between relieving layer and | 26 |
| ground electrode | |

As shown in Table 1, no separation occurred at even one sample between the iridium tip 120 and the relieving layer 110, while separation occurred at 26 samples between the relieving layer 110 and the ground electrode 100.

Therefore, the inventors discovered that the main reason for the separation between the relieving layer 110 and the ground electrode 100 was the reduction in the bonding strength. Therefore, the inventors took note of the interface between the relieving layer 110 and the ground electrode 100 and elucidated the reasons for the separation. As a result, the inventors judged that the separation at the interface between the relieving layer 110 and the ground electrode 100 easily occurred.

The reasons will be explained in detail using FIG. 1.

FIG. 1, as explained above, shows a ground electrode 100 made of a nickel-based alloy to a tip bonding portion of which is resistance welded an iridium alloy tip 120 comprised of Ir-10 wt % Rh through a relieving layer 110 comprised of Pt-20 wt % Ir-2 wt % Ni.

Further, by making the composition of the relieving layer 110 as explained above, the coefficient of linear expansion of the relieving layer 110 becomes one in the range between the iridium tip 120 and the tip bonding portion 100 and the Young's modulus of elasticity of the relieving layer 110 becomes smaller than that of the tip 120 comprised of an iridium alloy and the tip bonding portion 100.

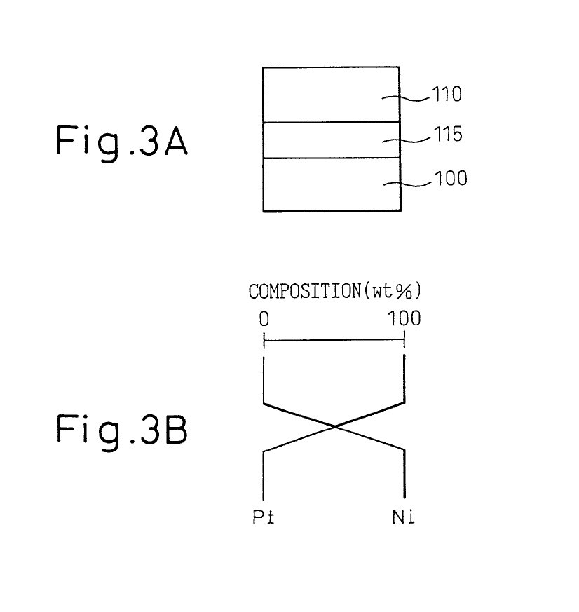

FIG. 2A is a schematic view of the state of the bonding interface in the initial state, while FIG. 2B is an explanatory view of the state of the bonding interface in the initial state. FIG. 3A is a schematic view of the state of the bonding interface in the state after a durability test, while FIG. 3B is an explanatory view of the state of the bonding interface in the state after a durability test.

As shown in FIG. 2A, a diffusion layer 115 of several microns thickness is formed at the interface between the relieving layer 110 and the ground electrode 100 in the initial case where the relieving layer 110 is resistance welded to the ground electrode 100. Therefore, the composition in the thickness direction of the diffusion layer 115 before the durability test, as shown in FIG. 2B, rapidly switches in ratios of platinum and nickel and therefore there is substantially no diffusion layer 115 present.

After the durability test, however, the thickness of the diffusion layer becomes greater. That is, the composition in the thickness direction in the diffusion layer 115 portion after the durability test, that is, after leaving the spark plug having the ground electrode 100 of FIG. 1 in an electric furnace at 900° C. for 5 hours, is shown in FIG. 3B.

As shown in FIG. 3A, after the durability test, the thickness of the diffusion layer 115 formed at the interface between the relieving layer 110 and the ground electrode 100 becomes a thickness of about 100 μm. The composition in the thickness direction exhibits a gentle change as shown in FIG. 3B. Therefore, in the diffusion layer 115, the alloying of the platinum component included in the relieving layer 110 and the nickel component included in the ground electrode progresses and two types of intermetallic compounds are formed by the nickel component and the platinum component.

The two types of intermetallic compounds are 23 wt % Ni-76 wt % Pt and 47.5 wt % Ni-52.5 wt % Pt. These intermetallic compounds do not have a coefficient of linear expansion and Young's modulus of elasticity according to the their compositions. Specifically, the coefficient of linear expansion of the intermetallic compounds is believed to be a value of about half of that of the iridium component. Further, the Young's modulus of elasticity of the intermetallic compounds is believed to be about double that of the iridium component.

Therefore, even if for example a relieving layer 110 is interposed, due to the production of intermetallic compounds having a small coefficient of linear expansion and a large Young's modulus of elasticity between the relieving layer 110 and the ground electrode 100, the relieving layer 110 and the ground electrode 100 easily end up separating.

In the present invention, the inventors took note of the above factors and selected a composition which would not form unpreferable intermetallic compounds between the relieving layer and the ground electrode.

As a result, as the composition of the tip bonding portion, they used an iron-based alloy having a coefficient of linear expansion and Young's modulus of elasticity about the same as a nickel-based alloy and not easily forming an intermetallic compound with a platinum component.

More specifically, in the first aspect of the invention set forth in claim 1, they used an iron-based alloy as the composition of the tip bonding portion and provided a relieving layer (61, 62) comprised of an alloy containing platinum having a coefficient of linear expansion in a range between that of the iridium alloy and the iron-based alloy of the material comprising the tip bonding portion (3a, 4a) (hereinafter referred to as the “electrode material”) and having a Young's modulus of elasticity smaller than the two alloys between the tip (51, 52) comprised of an iridium alloy essentially consisting of iridium and the tip bonding portion (3a, 4a).

In the present invention, by making the composition of the tip bonding portion an iron-based alloy rather than the conventional nickel-based alloy, only one type of intermetallic compound (22.24 wt % Fe-77.76 wt % Pt) is formed in the diffusion layer formed between the relieving layer (61, 62) and tip bonding portion. Therefore, compared with the related art, separation between the relieving layer and the tip bonding portion can be suppressed.

Further, the iron-based alloy forming the tip bonding portion becomes even closer to an iridium alloy in the coefficient of linear expansion compared with a nickel-based alloy comprising the conventionally known tip bonding portion. Therefore, by making the material comprising the tip bonding portion an iron-based alloy, it is possible to further improve the bond reliability of the tip comprised of the iridium alloy.

Further, an iron-based alloy is superior to a nickel-based alloy in heat resistance and oxidation resistance, so can be used even in an engine operating under a harsh heat load.

Still further, in the present invention, since the material comprising the relieving layer (61, 62) has a coefficient of linear expansion between that of the two alloys, it is possible to secure an action of relieving thermal stress at least equal to that of the past. Further, since it has a Young's modulus of elasticity smaller than that of the two alloys, it is possible to make the relieving layer (61, 62) softer and have the thermal stress of the bonding portion absorbed more efficiently. Therefore, due to the two effects, relief of the thermal stress of a higher level that the past becomes possible and the bonding of the tip can be improved.

Therefore, as stated in claim 2, the tip bonding portion (3a, 4a) is preferably an iron-based alloy containing at least 50 wt % of iron.

By making the content at least 50 wt %, it is possible to make the coefficient of linear expansion of the tip bonding portion closer to the coefficient of linear expansion of the iridium tip and possible to suppress the separation of the iridium tip from the tip bonding portion.

Further, it is also possible to suppress the formation of a plurality of intermetallic compounds.

Further, as stated in claim 3, the tip bonding portion (3a, 4a) preferably is comprised of an iron-based alloy containing at least 50 wt % of iron and a balance of at least one of chromium or aluminum.

Chromium and aluminum are extremely stable as oxides, so form dense chromium and aluminum oxide films on the surface of the electrode material in a high temperature atmosphere during the use of the engine and prevent the progress of oxidation to the inside, so the oxidation resistance at the tip bonding portion can be improved.

As stated in claim 4, when making the tip bonding portion an iron-based alloy, the coefficient of linear expansion at 900° C. of the relieving layer (61, 62) is preferably 9.2×10^{-5 to} 11.7×10⁻⁶ (/°C.).

This is because when the coefficient is smaller than 9.2×10⁻⁶ (/°C.), separation easily occurs at the interface between the iridium tip and the relieving layer, while when the coefficient of linear expansion is larger than 11.7×10⁻⁶ (/°C.), separation easily occurs at the interface between the tip bonding portion and the relieving layer.

Further, as stated in claim 5, the relieving layer (61, 62) preferably contains at least 60 wt % of platinum.

By including at least 60 wt % of platinum in the relieving layer (61, 62), it is possible to bring the coefficient of linear expansion and Young's modulus of elasticity of the iridium tip to a preferable range.

As stated in claim 6, when making the tip bonding portion an iron-based alloy, the Young's modulus of elasticity of the relieving layer (61, 62) at 900° C. is preferably not more than 15×10^{4 MPa.}

Further, as stated in claim 7, the Young's modulus of elasticity of the relieving layer (61, 62) at 900° C. is preferably at least 5×10⁴ MPa.

That is, when the Young's modulus of elasticity of the relieving layer at 900° C. is larger than 15×10⁴ MPa, the relieving layer itself becomes too hard and it becomes no longer possible to sufficiently absorb the thermal stress at the bonding portion with the iridium tip or tip bonding portion. Further, when the Young's modulus of elasticity of the relieving layer at 900° C. is smaller than 5×10⁴ MPa, the material forming the relieving layer becomes too soft and cracks are liable to form in the relieving layer itself rather than the bonding interface.

As set forth in claim 8, the thickness (t) of the relieving layer (61, 62) is preferably at least 0.2 mm.

Further, as set forth in claim 9, the thickness (t) of the relieving layer (61, 62) is preferably not more than 0.6 mm.

That is, when the thickness of the relieving layer is smaller than 0.2 mm, at the time of a durability test, cracks easily occur in the relieving layer itself. The thicker the relieving layer, the greater the effect of the relieving layer, but at a thickness larger than 0.6 mm, the effect of the relieving layer ends up becoming saturated, while if made thicker than 0.6 mm, the cost of the material only becomes greater.

A tip (51, 52) comprised of an iridium alloy essentially consisting of iridium, as set forth in the aspects of the invention in claim 10 or claim 11, may be one containing at least 50 wt % of iridium or one containing at least 50 wt % of iridium and containing at least one of rhodium, platinum, ruthenium, palladium, and tungsten added to the iridium.

Further, as set forth in claim 12, the relieving layer (61, 62) is preferably comprised of a first relieving layer (61a, 62a) arranged at the tip (51, 52) side and a second relieving layer (61b, 62b) arranged at the tip bonding portion (3a, 4a) side, the coefficient of linear expansion of the first relieving layer (61a, 62a) is between the coefficient of linear expansion of the tip (51, 52) and the coefficient of linear expansion of the second relieving layer (61b, 62b), and the coefficient of linear expansion of the second relieving layer (61b, 62b) is between the coefficient of linear expansion of the first relieving layer (61a, 62a) and the coefficient of linear expansion of the tip bonding portion (3a, 4a).

By adopting this configuration, it is possible to change the coefficient of linear expansion in steps between the iridium tip and the tip bonding portion and thereby possible to relieve the thermal stress in steps. Therefore, this is particularly effective when diameter of the tip is large. Here, as the first and second relieving layers, as set forth in the aspect of the invention set forth in claim 11, preferably use is made of a platinum-iridium alloy, platinum-nickel alloy, etc.

Further, in the invention set forth in claim 13, at the welded portion of the tip (51, 52) and the relieving layer (61, 62), the tip (51, 52) preferably has a larger outer circumference than the relieving layer (61, 62). By adopting this configuration, it is possible to improve the bonding since it is possible to reduce the thermal stress applied to the tip (51, 52) compared with the case where a relieving layer is welded to the entire surface of the tip in the welded portion.

Note that the reference numerals given in parentheses after the above means show the correspondence between the specific means of the embodiments described below. This present invention is not however limited by these.

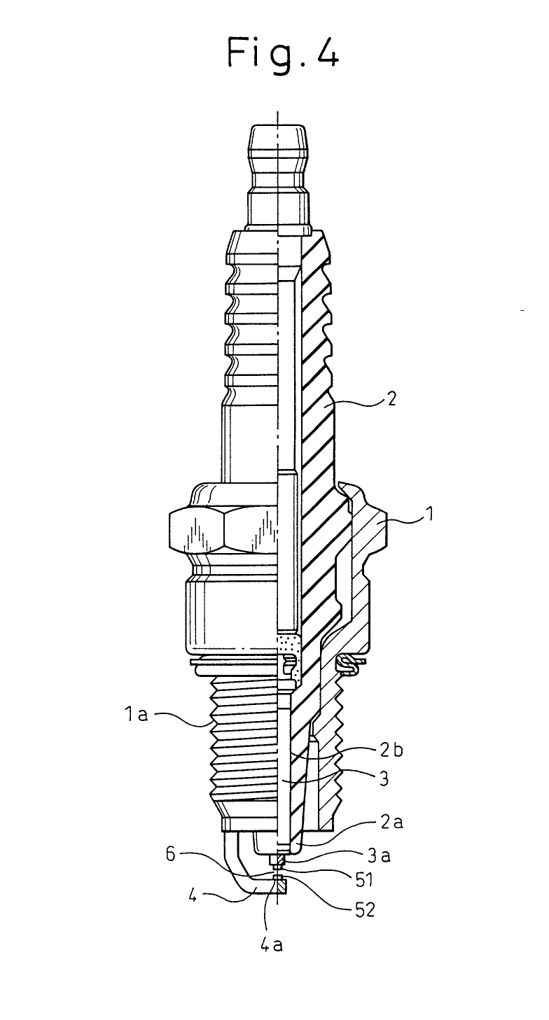

Next, an explanation will be made of embodiments illustrating the present invention. These embodiments are used as spark plugs of for example an internal combustion engine. FIG. 4 is a semi sectional view of the overall configuration of a spark plug of the present embodiment.

The spark plug has a cylindrically shaped shell 1. This shell 1 is provided with a threaded portion la for attachment to a not shown engine block. Inside of the insulator shell 1 is affixed an insulator 2 comprised of an alumina ceramic (Al₂O₃) etc. The front end 2a of the insulator 2 projects out from the shell 1.

The center electrode 3 is affixed to an axial hole 2b of the insulator 2 and is held insulated with respect to the shell 1 through the insulator 2. As shown in FIG. 1, the front end 3a of the center electrode 3 is provided so as to project from the front end 2a of the insulator 2. The center electrode 3 forms a cylindrical member comprised of copper or another metal material superior in heat conductivity as a not shown inside material and of an iron-based alloy or other metal material superior in heat resistance and corrosion resistance as an outside material.

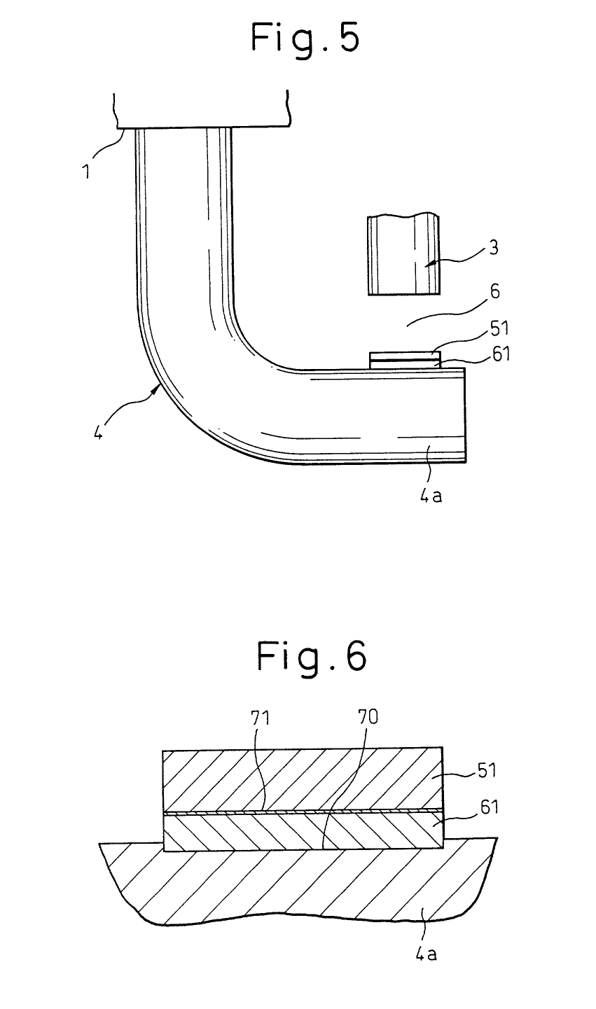

The ground electrode 4 is welded to one end of the shell 1 and is bent into a substantial L-shape in the middle. At the tip bonding portion opposite to the welded portion, that is, the facing portion 4a, it faces the front end 3a of the center electrode 3 across a discharge gap 6. The ground electrode 4 is comprised by a metal material superior in heat resistance and corrosion resistance. Here, FIG. 5 is an enlarged view of the facing portions of the two electrodes 3 and 4 in FIG. 4.

As shown in FIG. 5, an iridium tip (discharge layer) 51 comprised of an iridium alloy (in the present example, 90 wt % Ir-10 wt % Rh) is resistance welded to the portion 4a of the ground electrode 4 facing the center electrode 3 through a relieving layer 61. Here, FIG. 6 is a sectional view of the bonding portion of the tip 51.

The tip 51 is shaped as a disk of for example a diameter of 1.0 mm and a thickness of 0.3 mm. A discharge gap 6 is formed by the space between the center electrode 3 and the tip 51 (for example, about 1 mm). Further, the relieving layer 61 is a disk-shaped layer having a diameter the same as the tip 51 (for example, 1.0 mm) and a thickness of 0.4 mm. Here, the tip bonding portion, that is, the facing portion 4a, is comprised of an iron-based alloy. In this example, it is an Fe-15 wt % Cr-4 wt % Al alloy.

In the present embodiment, further, the material comprising the relieving layer 61 is made one having a coefficient of linear expansion α one of a range between the iridium alloy of the material comprising the tip 51 and the iron-based alloy of the electrode material comprising the facing portion 4a and having a Young's modulus of elasticity E smaller than the iridium alloy and iron-based alloy. Various experiments and studies were conducted relating to the material comprising the relieving layer 61. The invention was made based on the findings.

Specific values are shown in Table 2.

TABLE 2

| | Coefficient of | Young's modulus |
|---|---|---|
| | linear expansion | of elasticity |
| | (/° C.) | (MPa) |
| Iridium tip 51 | 7.8 × 10⁻⁶ | 38 × 10⁴ |
| Relieving layer 61 | 10.5 × 10⁻⁶ | 10.8 × 10⁴ |
| Facing portion 4a | 13.8 × 10⁻⁶ | 15 × 10⁴ |

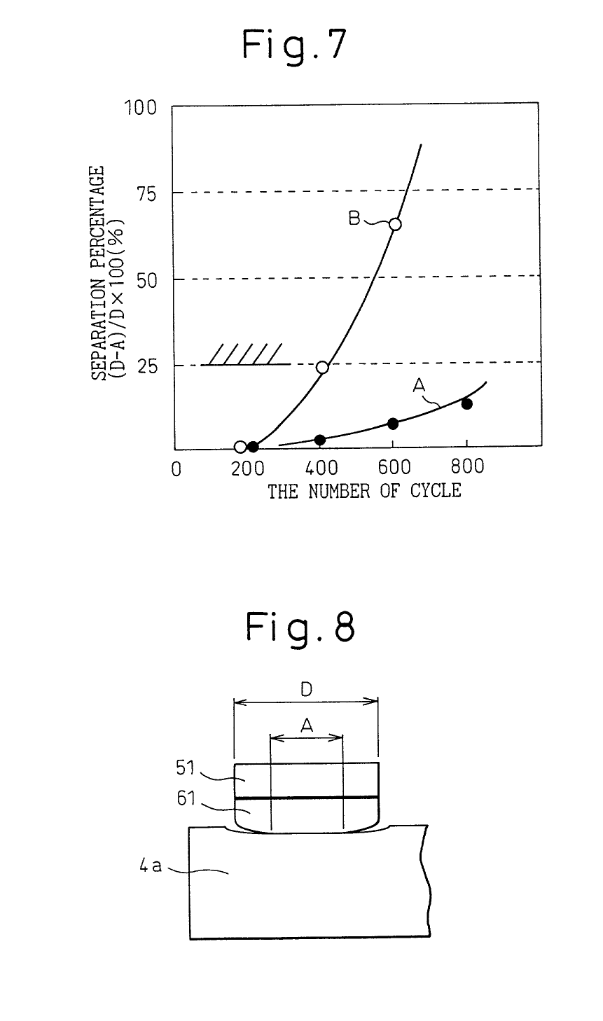

Next, the results of the degree of separation of the ground electrode and the relieving layer due to a durability test are shown in FIG. 7 for a spark plug 1 of the above configuration and a spark plug of the configuration of the related art, that is, one having an iridium tip comprised of Ir-10 wt % Rh resistance welded through a relieving layer comprised of Pt-20 wt % Ir-2 wt % Ni to a ground electrode comprised of Iconel (registered trademark), one type of a nickel-based alloy.

Here, A shows a spark plug using an iron-based alloy for the facing portion 4a of this example, while B shows a spark plug using a nickel-based alloy of the related art.

As the standard for evaluation in the durability test, as shown in FIG. 8, the rate of separation ((D-A)/D× 100) was found at the interface between the ground electrode 4 and the relieving layer 61 using the length in the diametrical direction of the relieving layer 61 as D and the length in the diametrical direction reliably bonded in the length in the diametrical direction of the relieving layer D as A. Further, during engine use, the possibility of separation and detachment due to the combustion pressure, vibration, and other work stress becomes larger, so the sample was evaluated as defective when the rate of separation was more than 25 percent.

As the durability test, use was made of an electric furnace heat-and-cool cycle test. A cycle consisted of exposure to an environment of 900° C. for 1 minute, then to an environment of 20° C. for 1 minute. The relationship between the number of cycles and rate of separation is shown in FIG. 6.

As clear from FIG. 7, it can be easily understood that a spark plug having a ground electrode comprised of an iron-based alloy of the present embodiment is much more resistant to separation than the related art.

As the reason for this, it is possible to obtain a unique effect by the iron-based alloy of suppressing the production of an intermetallic compound compared with a combination of a nickel-based alloy and platinum even if the diffusion layer formed at the bonding interface between the facing portion 4a of the ground electrode 4 and the relieving layer 61 becomes thicker after the durability test. By improving the bond reliability due to the employment of an iron-based alloy, a great increase in the plug replacement time becomes possible and the service life of the plug can be extended. Further, bonding with inexpensive resistance welding becomes possible and it is possible to obtain a low cost and high reliability plug having an iridium alloy tip. Further, the present embodiment is suitable for use for a spark plug used in a further tougher heat load environment.

In the above embodiment, resistance welding was performed twice, that is, the resistance welding of the relieving layer 61 to the tip bonding portion 4a and the resistance welding of the tip 51, but as another embodiment, it is also possible to perform resistance welding once of a cladding type tip comprised of a tip 51 and relieving layer 61 bonded together in advance.

Further, if the tip diameter becomes large, that is, if the area of the interface between the tip and the relieving layer and the area of the interface of the relieving layer and the tip bonding portion become larger, the thermal stress applied also becomes larger.

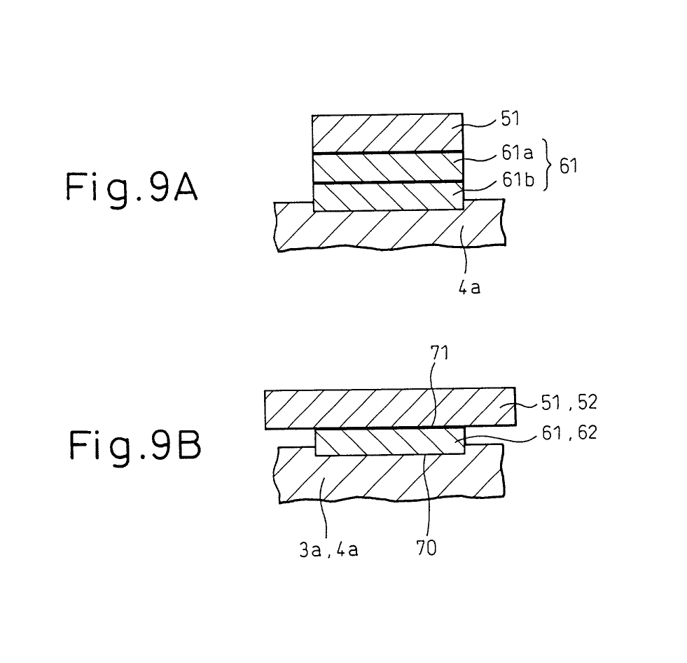

Therefore, a configuration corresponding to the increase in the tip diameter is shown in FIGS. 9A and 9B. In FIG. 9A, the relieving layer 61 is made a two-layer structure of a first relieving layer 61a arranged at the tip 51 side and a second relieving layer 61b arranged between the first relieving layer 61a and the tip bonding portion 4a.

In this case, it is possible to change the coefficient of linear expansion in steps between the tip 51 and the tip bonding portion 4a compared with the case of a single relieving layer 61 and, due to this, possible to relieve the thermal stress in steps as well. Therefore, the configuration of FIG. 9A is effective when the diameter of the tip is large (for example, at least 1.5 mm). For example, it is possible to use a platinum-iridium alloy as the first relieving layer and a platinum-iron alloy as a second relieving layer.

Further, in FIG. 9B, in the tip-relieving layer bonding face 71, if bonding a tip 51 larger in outer circumference than the relieving layer 61, that is, a tip 51 larger than the relieving layer 61, it is possible to secure bonding and greatly improve the consumption resistance. By making the diameter of the relieving layer 61 smaller than the tip diameter, even if the tip diameter is large, the thermal stress applied to the interface can be made smaller.

Note that the discharge layer member, that is, the tip 51, and the relieving layer 61 may also be configured as a rod shape and a rectangular shape in addition to a disk shape.

In the above embodiment, the explanation was made of the configuration making the ground electrode out of an iron-based alloy and resistance welding the iridium tip to the ground electrode comprised of this iron-based alloy. The present invention, however, is not limited to the ground electrode. In the center electrode comprised of the iron-based alloy, it is also possible to resistance weld the iridium tip by the above configuration to the portion of the center electrode facing the ground electrode.

Here, a preferable coefficient of linear expansion of the relieving layer in the case of making the tip bonding portion in the present invention an iron-based alloy will be considered.

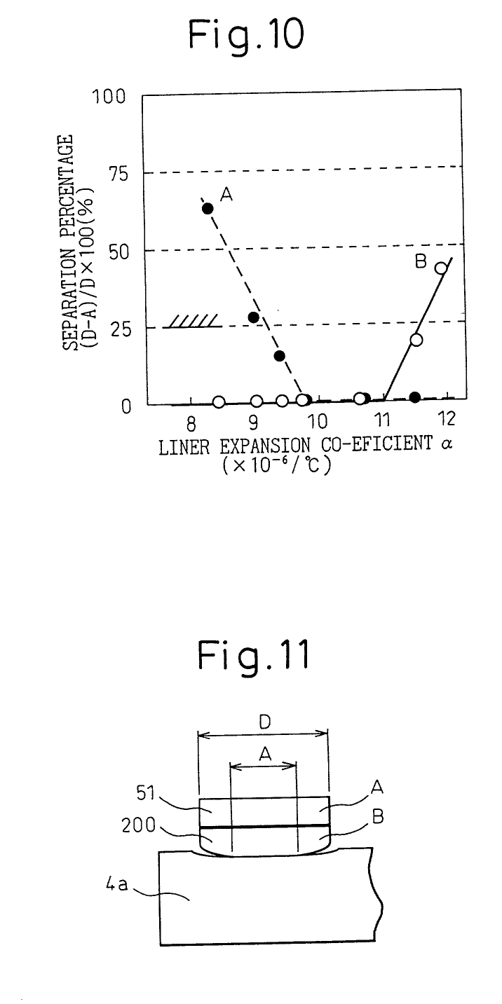

FIG. 10 shows the rate of separation of the interface A between the iridium tip 51 and the relieving layer 200 and the rate of separation of the interface B between the facing portion 4a of the tip bonding portion of the ground electrode and the relieving layer 200 in the case of changing the linear expansion of the relieving layer 200.

Here, the facing portion 4a of the ground electrode 4 and the iridium tip 51 are made using the same material as the first embodiment. Further, the relieving layer 200 is changed in coefficient of linear expansion by changing the platinum content to at least 60 wt %, the iridium to 10 to 40 wt %, the nickel to 0 to 5 wt %, and the iron to 10 to 20 wt %.

Here, the condition of the rate of separation was made the same as the condition of FIG. 7 and the defect rate was made at least 25 percent. Further, the method shown in FIG. 11 was used to find the rate of separation.

As clear from FIG. 10, when the coefficient of linear expansion of the relieving layer 200 is not more than 9×10⁻⁶/°C., the rate of separation becomes at least 25 percent at the interface B between the facing portion 4a of the tip bonding portion of the ground electrode 4 and the relieving layer 200. When the coefficient of linear expansion becomes more than 11.7×10⁻⁶/°C., the rate of separation of the interface A between the iridium tip 51 and the relieving layer 2000 becomes at least 25 percent.

The reason is that when the coefficient of linear expansion of the relieving layer 200 is not more than 9.2× 10⁻⁶/°C., the coefficient of linear expansion between the relieving layer 200 and the facing portion 4a ends up becoming large and separation ends up easily occurring. Further, this is believed due to the fact that when the coefficient of linear expansion of the relieving layer 200 is more than 1.7×10⁻⁶/°C., the coefficient of linear expansion of the relieving layer 200 and the iridium tip 51 ends up becoming large and separation ends up easily occurring.

The preferable Young's modulus of elasticity and thickness of the relieving layer was confirmed to not be dependent on the composition of the tip bonding portion.

While the invention has been described by reference to specific embodiments chosen for purposes of illustration, it should be apparent that numerous modifications could be made thereto by those skilled in the art without departing from the basic concept and scope of the invention.

What is claimed is:

1. A spark plug provided with
a center electrode (3);
an insulator shell (1) holding the center electrode (3);
a ground electrode (4) fixed at the insulator shell (1) and facing the center electrode (3) across a discharge gap;
a tip (51, 52) comprised of an iridium alloy essentially consisting of iridium bonded to said center electrode (3) and/or said ground electrode (4) at facing portions of said electrodes (3, 4); and
a stress relieving layer (61, 62) arranged between the tip and a tip bonding portion (3a, 4a) of the center electrode (3) and/or ground electrode (4) to which the tip (51, 52) is bonded;
the tip bonding portion (3a, 4a) being comprised of an iron-based alloy; and
the relieving layer (61, 62) being comprised of an alloy including platinum having a coefficient of linear expansion between that of the iridium alloy and said iron-based alloy and having a Young's modulus of elasticity smaller than said iridium alloy and said iron-based alloy.

2. A spark plug according to claim 1, wherein said tip bonding portion (3a, 4a) is comprised of an iron-based alloy containing at least 50 wt % of iron.

3. A spark plug according to claim 2, wherein said tip bonding portion (3a, 4a) is comprised of an iron-based alloy containing at least 50 wt % of iron and a balance of at least one of chromium and aluminum.

4. A spark plug according to claim 1, wherein the coefficient of linear expansion of said relieving layer (61, 62) at 900° C. is 9.2×10⁻⁶ to 11.7×10⁻⁶ (/°C.).

5. A spark plug according to any one of claims 1 to 4, wherein said relieving layer (61, 62) contains at least 60 wt % of platinum.

6. A spark plug according to any one of claims 1 to 5, wherein a Young's modulus of elasticity of said relieving layer (61, 62) at 900° C. is not more than 15× 10⁴ MPa.

7. A spark plug according to any one of claims 1 to 6, wherein a Young's modulus of elasticity of said relieving layer (61, 62) is at least 5×10⁴ MPa.

8. A spark plug according to any one of claims 1 to 7, wherein a thickness (t) of said relieving layer (61, 62) is at least 0.2 mm.

9. A spark plug according to any one of claims 1 to 8, wherein a thickness (t) of said relieving layer (61, 62) is not more than 0.6 mm.

10. A spark plug according to any one of claims 1 to 9, wherein said tip (51, 52) contains at least 50 wt % of iridium.

11. A spark plug according to any one of claims 1 to 10, wherein said tip (51, 52) contains at least 50 wt % of iridium and contains at least one of rhodium, platinum, ruthenium, palladium, and tungsten added to said iridium.

12. A spark plug according to claim 1, wherein said relieving layer (61, 62) is comprised of a first relieving layer (61a, 62a) arranged at said tip (51, 52) side and a second relieving layer (61b, 62b) arranged at said tip bonding portion (3a, 4a), the coefficient of linear expansion of said first relieving layer (61a, 62a) is between the coefficient of linear expansion of said tip (51, 52) and the coefficient of linear expansion of said second relieving layer (61b, 62b), and the coefficient of linear expansion of the second relieving layer (61b, 62b) is between the coefficient of linear expansion of said first relieving layer (61a, 62a) and the coefficient of linear expansion of said tip bonding portion (3a, 4a).

13. A spark plug according to any one of claims 1 to 12, wherein said tip (51, 52) is larger in outer circumference than said relieving layer (61, 62).
